(19) United States
(12) Patent Application Publication
(10) Pub. No.: US 2023/0195098 A1
(43) Pub. Date: Jun. 22, 2023

(54) SYSTEMS AND METHODS FOR ACTIVE FAULT DETECTION OF AN HVAC SYSTEM AND ITS ASSOCIATED MECHNICAL EQUIPMENT

(71) Applicant: Siemens Industry, Inc., Alpharetta, GA (US)

(72) Inventors: David E. Bornside, Palatine, IL (US); Robert L. Johnson, Lincolnshire, IL (US); Kimberly Barker, Palatine, IL (US)

(21) Appl. No.: 17/556,015

(22) Filed: Dec. 20, 2021

(51) Int. Cl. G05B 23/02; G05B 15/02

(52) U.S. Cl. CPC G05B 23/0262; G05B 23/0235; G05B 23/0237; G05B 15/02

(57) ABSTRACT

There is described a system and method for active fault detection of an HVAC system and its associated mechanical equipment comprising building automation controllers and a remote device. A request for active fault detection of controllers of a building automation system (“BAS”) network is received. A passive test associated with each controller is executed by analyzing the controller via read-only access to operations of the controller. The passive test includes identifying a fault condition and a work item associated with the controller or a mechanical device connected to the controller. A full range full range active test based on the fault condition and the work item associated with each controller is executed by analyzing the controller via direct command access to the operations of the controller. A controller function associated with the request for active fault detection of the controllers is performed in response to executing the full range active test.

### FIELD OF THE INVENTION

This application relates to the field of controllers of building automation systems and, more particularly, to active fault detection of an HVAC system and its associated mechanical equipment.

### BACKGROUND

Building automation systems encompass a wide variety of systems that aid in the monitoring and control of various aspects of building operation. Building automation systems include security systems, fire safety systems, lighting systems, and heating, ventilation, and air conditioning (“HVAC”) units. Each building automation system includes multiple programmable, or otherwise configurable, controllers to manage various building environmental functions. These programmable/configurable controllers support customizable sequences of operation and may be configured to support multiple mechanical system variants. Accordingly, initial job commissioning processes and continuous commissioning processes may be quite complex.

For initial job commissioning, a field technician manually checks each device and is required to understand the details of each device's standard or customized control sequence, in order to determine that the device is functioning properly in relation to the connected mechanical components. The technician is also required to understand the details of the mechanical equipment controlled by each device to determine how to link operational issues to individual components. The technician is further required to understand how to manipulate individual elements of the control sequence to isolate individual mechanical components for test. If the technician does not understand these details, then issues may be missed or attributed to an identification of a wrong root cause.

For continuous commissioning, where testing may occur months or years after installation, it is much more difficult and labor-intensive to check out the system. This is particularly true where control sequences have been revised and mechanical components replaced. In the interoperable world, where controllers with similar features may exist on a single job, gaining the necessary level of understanding to perform initial or continuous commissioning tasks adds yet another level of difficulty and associated cost.

Some existing systems utilize small-scale or specialized solutions for initial and continuous commissioning. One type is manual commanding of each mechanical component in each device, measuring the results, and comparing the behavior against the desired behavior. This approach is not scalable or repeatable over a product lifecycle. Also, the cost for high-volume devices is prohibitive so, typically, this is done on a spot-check basis.

Another type is embedded diagnostics where individual devices may have features allowing them to identify mechanical system issues. For example, feedback sensors may generate alarm and fault conditions based on sensor states. Yet another type is vendor-specific diagnostic tools that exercise vendor devices and generate reports of findings. Embedded diagnostics and vendor-specific diagnostic tools are not system-level solutions because they are not consistent in operation or test coverage across devices, manufacturers, or product generations.

Still another type is custom analytics where general-purpose analytics packages, such as SkySpark® by SkyFoundry, LLC, of Glen Allen, Va., and Niagara Analytics by Tridium, Inc., of Richmond, Va., provide environments for developing diagnostic functions. General-purpose analytics packages are typically passive and based on historical data logs. In particular, the analytics packages are platforms for passive analytics and data analysis, but passive analytics are not able to isolate individual mechanical and control elements, so they depend on trend analysis to identify possible incorrect behavior.

These existing systems are limited in their ability to address the technical and cost issues associated with initial and continuous commissioning.

### SUMMARY

In accordance with one embodiment of the disclosure, there are provided systems and methods for active fault detection of an HVAC system and its associated mechanical equipment. The systems and methods include both passive and active elements to address the issues associated with initial and continuous commissioning. One or more passive tests are performed or executed by utilizing read-only access. One or more active tests are performed or executed by providing commands to the building automation controllers during the active test(s). Active analytics enhance passive analytics because they may command devices into states suitable for testing and read values back in near realtime for analysis and report generation.

One aspect is a system for active fault detection of an HVAC system and its associated mechanical equipment comprising building automation controllers of a building automation system (“BAS”) network and a remote device communicating with the building automation controllers. The remote device receives a request for active fault detection of the building automation controllers. The remote device also executes a passive test associated with each building automation controller by analyzing the building automation controller via read-only access to the operations of the building automation controller. The passive test includes identifying a fault condition and a work item associated with the building automation controller or a mechanical device connected to the building automation controller. The remote device further executes a full range active test based on the fault condition and the work item associated with the building automation controller by analyzing the building automation controller via command-and-read access to the operations of the building automation controller. The remote device still further performs a controller function associated with the request for active fault detection of the building automation controllers in response to executing the full range active test.

Another aspect is a method for active fault detection of an HVAC system and its associated mechanical equipment. A request for active fault detection of a building automation controllers of a BAS network is received. A passive test associated with each building automation controller is executed by analyzing the building automation controller via read-only access to operations of the building automation controller. The passive test includes identifying a fault condition and a work item associated with the building automation controller or a mechanical device connected to the building automation controller. A full range active test based on the fault condition and the work item associated with each building automation controller is executed by analyzing the building automation controller via direct command access to the operations of the building automation controller. A controller function associated with the request for active fault detection of the building automation controllers is performed in response to executing the full range active test.

The above described features and advantages, as well as others, will become more readily apparent to those of ordinary skill in the art by reference to the following detailed description and accompanying drawings. While it would be desirable to provide one or more of these or other advantageous features, the teachings disclosed herein extend to those embodiments which fall within the scope of the appended claims, regardless of whether they accomplish one or more of the above-mentioned advantages.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects.

FIG. 1 is an illustration of a fault detection and diagnostics (“FDD”) system in an example implementation that is operable to employ techniques described herein.

FIG. 2 is a block diagram representing an example implementation of the remote FDD server and each mobile device of FIG. 1.

FIG. 3 is a block diagram representing the customer gateway, in an example implementation, of FIG. 1.

FIGS. 4A and 4B are tables representing device configurations and active tests that may be applied to the building automation controllers of FIG. 1.

FIGS. 5A and 5B are flow diagrams of an FDD operation in an example implementation that is operable to employ techniques described herein.

FIG. 6 is a flow diagram representing the passive test operation, in an example implementation, of FIG. 5A.

### DETAILED DESCRIPTION

Various technologies that pertain to systems and methods that facilitate passive and active fault detection system of an HVAC system and its associated mechanical equipment will now be described with reference to the drawings, where like reference numerals represent like elements throughout. The drawings discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged apparatus. It is to be understood that functionality that is described as being carried out by certain system elements may be performed by multiple elements. Similarly, for instance, an element may be configured to perform functionality that is described as being carried out by multiple elements. The numerous innovative teachings of the present application will be described with reference to exemplary non-limiting embodiments.

The active fault detection system utilizes an on-site gateway controller or remote server for passively and actively testing a building automation system (BAS) controller. The system may perform active fault detection of the BAS controller for monitoring and controlling a heating, ventilation, and air conditioning (HVAC) system and its associated mechanical devices via passive tests. For example, the passive test may read and analysis status of inputs, outputs, and configuration without interrupting existing control and override functions. The system may also, based on results of passive tests and any identified faults, identify the proper active tests for the identified mechanical devices under control of the BAS controller and perform the active tests with the identified mechanical device to identify the root cause of any identified fault associated with the mechanical device. Examples of mechanical devices of the HVAC system to be tested may include, but are not limited to, a Supply Air Damper(s), Extract Air Damper, Terminal Cooling Coil, Terminal Heating Coil, Heating/Cooling Coil, Outside/Return Air Damper, Radiator coil, and Radiant ceiling coil.

The active fault detection system provides improved system performance and reduced costs in terms of service and effort. The system combines passive and active analysis, allowing consistent operation across a wide range of control sequences and mechanical equipment. Deep knowledge of device deployments, such as I/O type, whether water or electric heat is used, etc. may not be required. This simplification reduces service costs and effort. The system may also be applied to specific devices and communication protocols or, with use of integration platform features, multi-vendor and multi-protocol systems. The system may operate with existing I/O, and installation of additional I/O may not be required. Installation of feedback sensors and the associated configuration of state notifications adds significant cost and is rarely done. Further, the system does not require custom programming, may not be dependent on availability of logged data, and may be deployed at on-site location and/or in the Cloud. Tests may be executed without requiring personnel to travel to the site, many issues may be resolved via remote access, and travel to the site may only be necessary if results indicate issues with physical components, thus minimizing the need to do manual testing and analysis. The active analytics of active fault detection system are capable of commanding devices into states suitable for testing and read values back in near real-time for analysis and report generation.

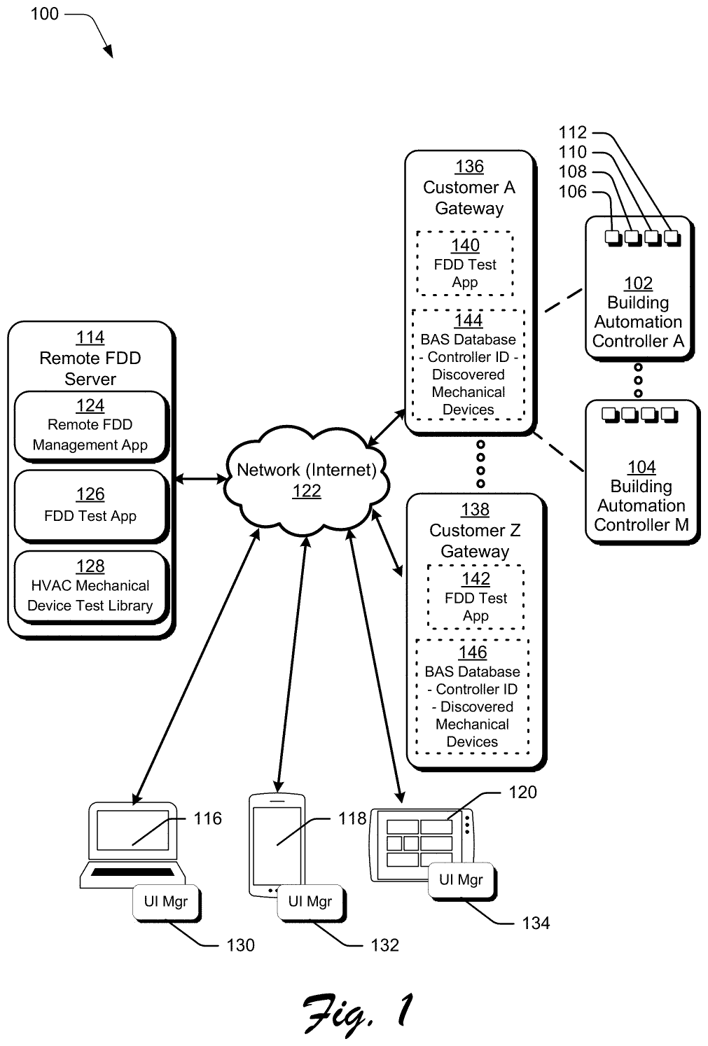

Referring to FIG. 1, there is shown a system 100 for active fault detection of an HVAC system and its associated mechanical equipment that includes one or more controllers of building automation systems, i.e., building automation controllers 102, 104. Each building automation controller 102, 104 includes one or more mechanical devices 106-112 connected to the building automation controller. Examples of mechanical devices 106-112 of an HVAC unit include, but are not limited to, variable air volume, constant volume, fan coil, unit vent, heat pump, chilled beam, dual duct applications, and room automation devices.

The system 100 further includes a remote device 114-120 communicating with each other via a network 122, such as the Internet. The remote device may be a stationary device, such as a server 114, or a mobile device 116-120. For example, a remote fault detection and diagnostics (“FDD”) server 114 and one or more mobile devices 116-120 may be interconnected by the network 122 to the building automation controller 102, 104. The remote FDD server 114 may be deployed as a cloud service, or independently, for communication with the building automation controller 102, 104. A mobile device 116-120 may be deployed as portable communication device operated by service operators or technicians for communication with the building automation controller 102, 104, and the remote FDD server 114. Examples of mobile devices 116-120 include, but are not limited to, portable computing devices 116, smartphones 118, tablet devices 120, desktop computing devices, kiosk-supported devices, wearable devices, and the like.

The remote FDD server 114 and the mobile devices 116-120 may include apps and data to manage their respective operations. For example, the remote FDD server 114 may include a remote FDD management app 124 to manage general fault detection and diagnostics for the remote FDD server as well as receiving any requests for active fault detection of the building automation controllers 102, 104. The remote FDD server 114 also may include an FDD test app 126 to perform passive and full range active tests of the building automation controllers 102, 104. The passive test associated with each building automation controller 102, 104 analyzes the building automation controller via read-only access to the operations of the building automation controller. The passive test includes identifying a fault condition and a work item associated with the building automation controller or a mechanical device connected to the building automation controller. The active test is executed based on the fault condition and the work item associated with the building automation controller 102, 104 by analyzing the building automation controller via direct command access to the operations of the building automation controller.

The system 100 may generate diagnostic results and suggested fixes based on collected raw data. For some embodiments, the customer gateway 136, 138 may collect the raw data and generate results, which are shared with one or more remote devices 114-120. For some embodiments, one or more remote devices 114-120 may collect raw data associated with the active test, and the remote device(s) may generate diagnostic results and suggested fixes in response to collecting the raw data. The remote device 114-120 may output a report of diagnostic results and suggested fixes for each building automation controller. For some embodiments, the remote device 114-120 may perform a modification for a particular controller in response to executing the passive and active tests or, more particularly, in response to the active test.

For some embodiments, the remote FDD server 114 may include an HVAC mechanical device test library 128 for providing information to test one or more mechanical devices associated with the building automation controller 102, 104. For example, the HVAC mechanical device test library 128 may provide data the FDD testing app 126 to assist with identify one or more mechanical devices connected to the building automation controller 102, 104. As another example, the HVAC mechanical device test library 128 may provide data to the FDD testing app 126 to assist with resolving all fault conditions and work items associated with mechanical devices connected to the building automation controllers 102, 104. As another example, the HVAC mechanical device test library 128 may provide data to the FDD testing app 126 to assist with identifying a pre-requisite test to confirm conditions for isolating a mechanical device for the active test.

Each mobile device 116-120 may include a mobile app 130-134 that is registered with the remote FDD server 114 for operation within the system 100. The mobile app 130-134 provides a service technician or other device user to provide information and/or control one or more operations of the FDD test. For some embodiments, the mobile device 116-120 may operate in conjunction with the remote FDD server 114 for active fault detection of the building automation controllers 102, 104. For example, the mobile device 116-120 may send a request for active fault detection of one or more building automation controllers 102, 104 of the BAS network to the remote FDD server 114 so that the remote FDD server may execute the passive and active tests. Also, the remote FDD server 114 may provide instructions at a user interface of the mobile device 116-120 for performing an action, providing data from, or performing a controller function at the building automation controller 102, 104. For some embodiments, the mobile device 116-120 may operate independent of the remote FDD server 114 for active fault detection of the building automation controllers 102, 104, by executing the passive and active tests and performing the controller function associated with the request for active fault detection of the plurality of building automation controllers in response to executing the active test.

The system 100 may further include one or more customer gateways 136, 138 associated with the building automation controller or controllers 102, 104. Each customer gateway 136, 138 is associated with a particular customer and corresponds to at least one building automation controller 102, 104 of the particular customer. For embodiments that include customer gateways 136, 138, each customer gateway interconnects its corresponding building automation controller 102, 104 to the remote device 114-120 via one or more networks 122. In this matter, each customer gateway 118, 120, provides the remote device 114-120 with access and control of various controllers and subsystems of the corresponding the building management system of the customer, such comfort (e.g., HVAC and lighting), safety, or security controllers and subsystems.

For embodiments that include customer gateways 136, 138, each customer gateway facilitates communications between the remote device 114-120 and the building automation controller 102, 104. For some embodiments, one or more of the remote devices 114-120 or the customer gateway 136, 138 discover the building automation controllers 102, 104 on the BAS network in response to receiving a request for active fault detection of the building automation controllers. The remote devices 114-120 or the customer gateway 136, 138 may the request another device 114-120, 136, 138 of the system 100 or a user interface of the receiving device 114-120, 136, 138. For some embodiments, preceding the execution of the active test, the remote device 114-120 or the customer gateway 136, 138 passively interrogates all building automation controllers 102, 104. In addition, all fault conditions and work items associated with the building automation controllers 102, 104 or mechanical devices 106-112 connected to the building automation controllers are resolved by the remote device 114-120 and one or more building automation controllers.

Each customer gateway 136, 138 includes an FDD test app 140, 142 to perform passive and full range active tests of the building automation controllers 102, 104. The customer gateway or gateways 136, 138 operate in conjunction with one or more FDD test apps of the remote devices 114-120 to perform the passive and active tests. For some embodiments, each customer gateway 136, 138 may also include a BAS database 144, 146 that stores information about the building automation controllers 102, 104 and/or the mechanical devices 106-112, such as controller identifications for each controller and information about mechanical devices discovered by the customer gateway. A BAS database 144, 146 at the customer gateway 136, 138 is not required for operation of the system 100. For embodiments where a BAS database 144, 146 is available, the system 100 may utilize the BAS database for active fault detection or the system may ignore it. For embodiments, where a BAS database 144, 146 is not available, the system 100 may build its own database of discovered data based on a scan of the network. In this manner, the system 100 may “learn” about the connected controllers and devices without all time-consuming engineering (e.g., building databases) being performed in advance.

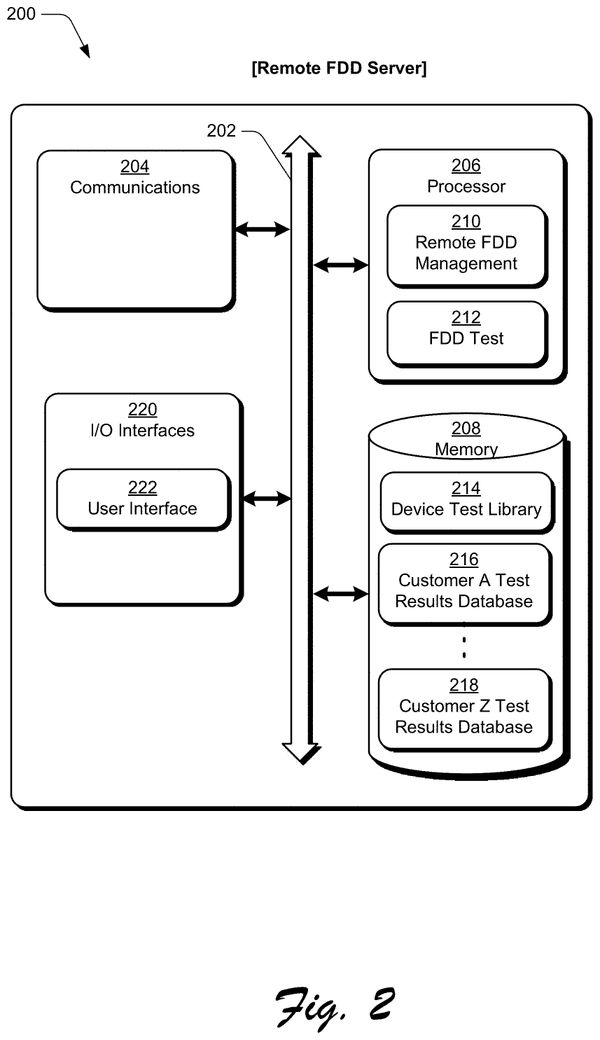

FIG. 2 represents example device components 200 of the remote FDD server 114 or each mobile device 116-120 in accordance with the active fault detection of the building automation controller. The device components 200 comprise a communication bus 202 for interconnecting the other device components directly or indirectly, one or more communication components 204 communicating other entities via a wired or wireless network, one or more processors 206, and one or more memory components 208. The one or more processors 206 may execute code and process data received at other components of the device components 200, such as information received at the communication component 204 or stored at the memory component 208. The code associated with the remote device 114-120 and stored by the memory component 208 may include, but is not limited to, operating systems, applications, modules, drivers, and the like. An operating system includes executable code that controls basic functions of the remote device 114-120, such as interactions among the various components of the device components 200, communication with external devices via the communication component 204, and storage and retrieval of code and data to and from the memory component 208.

Each application includes executable code to provide specific functionality for the processor 206 and/or remaining components of the remote device 114-120. An example of an application executable by the processor 206 includes, but is not limited to, a remote FDD management app module 210 to manage general fault detection and diagnostics for the remote FDD server as well as receiving any requests for active fault detection of the building automation controllers 102, 104, and an FDD test module 212 to perform passive and full range active tests of the building automation controllers 102, 104.

Data, stored by the memory component 208, is information that may be referenced and/or manipulated by an operating system or application for performing functions of the remote device 114-120. Examples of data stored by the memory component 208 may include, but are not limited to, a device test library 214 for providing information to test one or more mechanical devices associated with the building automation controller 102, 104, and a customer test results database 216, 218 to store data produced from passive and/or full range active tests corresponding to the building automation controllers 102, 104 for each customer.

The device components 200 of the remote device 114-120 may further comprise Input/Output (I/O) interfaces 220 having one or more input components and/or one or more output components. The I/O interfaces 220 of the device components 200 may include one or more visual, audio, mechanical, and/or other components. A user interface 222 of the device components 200 may include portions of the input and output components of the I/O interfaces 220 and be used to interact with a user of the remote device 114-120. For example, the user interface 222 may include a combination of hardware and software to provide a user with a desired user experience.

It is to be understood that FIG. 2 is provided for illustrative purposes only to represent examples of the device components 200 of the remote device 114-120 and is not intended to be a complete diagram of the various components that may be utilized by each device. The remote device 114-120 may include various other components not shown in FIG. 2, may include a combination of two or more components, or a division of a particular component into two or more separate components, and still be within the scope of the present invention.

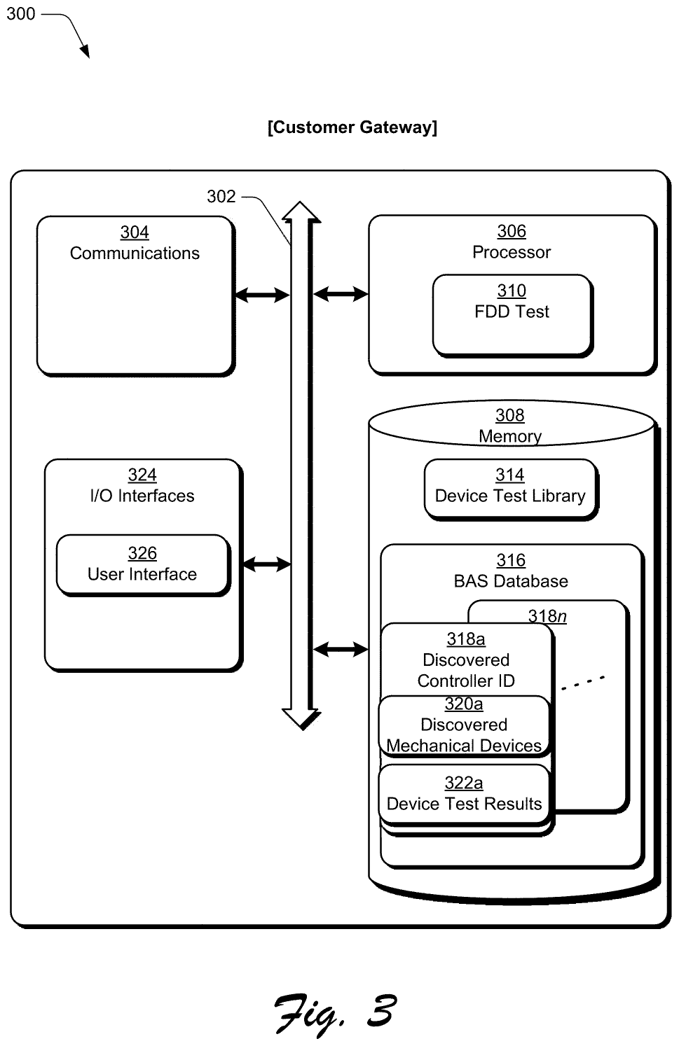

For those embodiments that include a customer gateway 136, 138, FIG. 3 represents example device components 300 of the customer gateway in accordance with the active fault detection of the building automation controller. The device components 300 comprise a communication bus 302 for interconnecting the other device components directly or indirectly, one or more communication components 304 communicating other entities via a wired or wireless network, one or more processors 306, and one or more memory components 308. The one or more processors 306 may execute code and process data received at other components of the device components 300, such as information received at the communication component 304 or stored at the memory component 308. The code associated with the customer gateway 136, 138 and stored by the memory component 308 may include, but is not limited to, operating systems, applications, modules, drivers, and the like. An operating system includes executable code that controls basic functions of the customer gateway 136, 138, such as interactions among the various components of the device components 300, communication with external devices via the communication component 304, and storage and retrieval of code and data to and from the memory component 308.

Each application includes executable code to provide specific functionality for the processor 306 and/or remaining components of the customer gateway 136, 138. An example of an application executable by the processor 306 includes, but is not limited to, an FDD test module 310 to perform passive and full range active tests of the building automation controllers 102, 104. The customer gateway or gateways 136, 138 operate in conjunction with one or more FDD test apps of the remote devices 114-120 to perform the passive and full range active tests.

Data, stored by the memory component 308, is information that may be referenced and/or manipulated by an operating system or application for performing functions of the customer gateway 136, 138. Examples of data stored by the memory component 308 may include, but are not limited to, a device test library 314 and a building automation system (“BAS”) database 316 including a controller identification 318a . . . 318n for each building automation controller 102, 104 discovered by a remote device 114-120 or a customer gateway 136, 138. Each controller ID may be associated with a mechanical device 320a . . . 320n discovered by a remote device 114-120 or a customer gateway 136, 138 and corresponding device test results 322a . . . 322n.

The device components 300 of the customer gateway 136, 138 may further comprise Input/Output (I/O) interfaces 324 having one or more input components and/or one or more output components. The I/O interfaces 324 of the device components 300 may include one or more visual, audio, mechanical, and/or other components. A user interface 326 of the device components 300 may include portions of the input and output components of the I/O interfaces 324 and be used to interact with a user of the customer gateway 136, 138. For example, the user interface 326 may include a combination of hardware and software to provide a user with a desired user experience.

It is to be understood that FIG. 3 is provided for illustrative purposes only to represent examples of the device components 300 of the customer gateway 136, 138 and is not intended to be a complete diagram of the various components that may be utilized by each device. The customer gateway 136, 138 may include various other components not shown in FIG. 3, may include a combination of two or more components, or a division of a particular component into two or more separate components, and still be within the scope of the present invention.

Passive and Active Tests

Passive tests precede full range active tests and, thus, may be referred to as pretests. A pretest includes five activities: identifying relevant objects and properties, checking object states, determining device configuration, determining whether to continue to active tests, and capturing pretest results for use in reports.

To identify relevant objects and properties, the FDD test app 126, 130-134, 140, 142 and/or corresponding data 128, 144, 146 specify a set of objects (such as input, output, value, structured view, and program objects) and properties used in pretests and full range active tests. For some embodiments, the set of objects and properties encompass objects and properties for all supported test configurations. For some embodiments, a single building automation controller 102, 104 may include only a subset of objects that apply to its specific configuration. The pretest is responsible for scanning the building automation controller 102, 104 under test and capturing a list of relevant objects and properties.

Each device may be scanned to build an image of the mechanical components that it controls. For well-known devices, this task may be completed by scanning objects in the device using internal device hierarchies and object names. For devices that are not well known, such as third-party devices, scanning may be done through use of semantic tags as described below. Scanning via internal hierarchies, point names, and/or semantic tags applies to fixed application controllers, configurable application controllers, and programmable controllers.

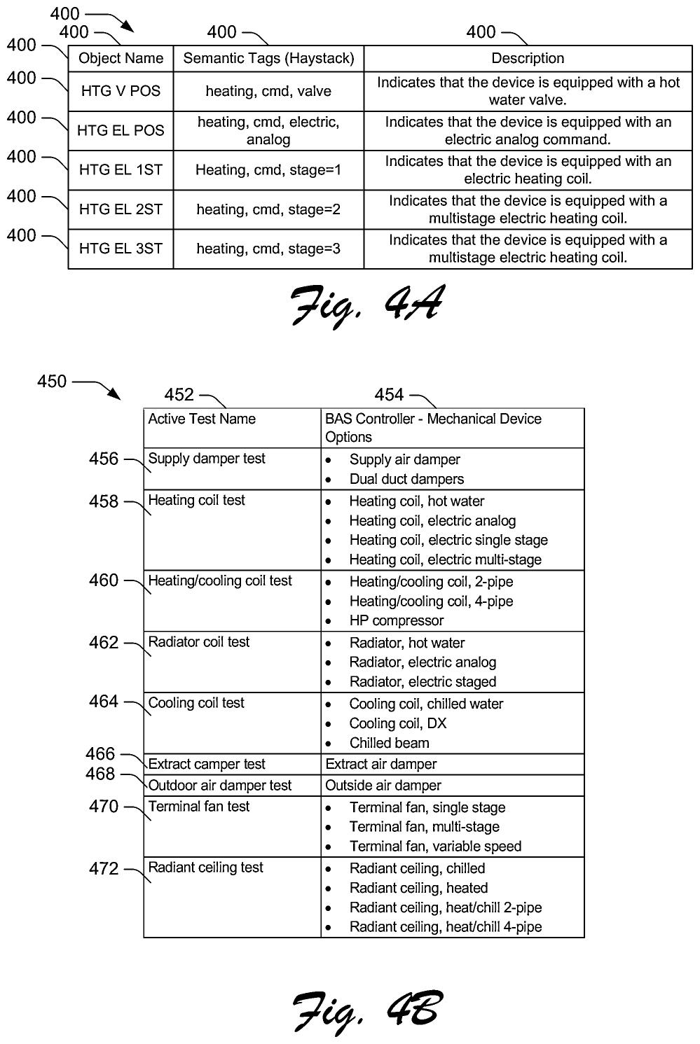

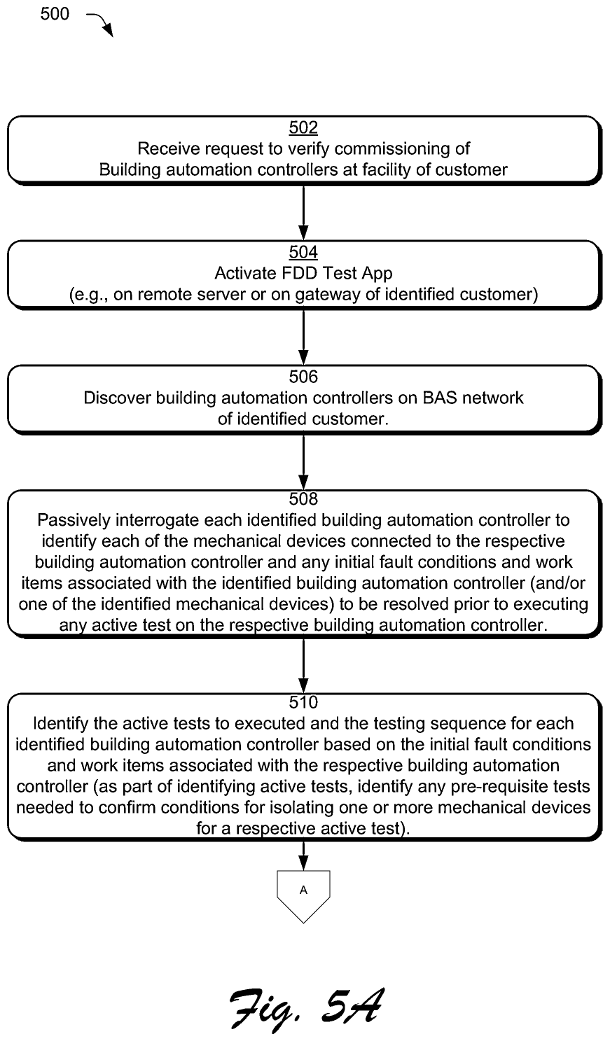

Referring to FIG. 4A, there is shown a table that may determine device configurations of the building automation controllers. For example, an image of the mechanical system may be built to determine device configuration. The existence of objects with the names and/or semantic tags may be identified which, for this example, indicates the existence of a heating coil. If these objects are not found, the heating coil active test will not be executed. Using the lists of relevant objects and properties captured in the previous steps, the FDD application will identify the set of test peripherals relevant to FDD passive and active tests.

In order for full range active tests to properly diagnose controller operations, it is necessary to determine that the control process is operating as intended. If object values are overridden via software or mechanical means, the process will not operate as expected. If wiring faults or other error conditions exist, the process will not operate as expected. If the process is not functioning as intended, active tests are likely to misidentify the root cause of any errors that may exist. Examples of fault and override checks include, but are not limited to, checking for out-of-service and fault states, checking for commands at elevated priorities, and checking for application lock commands (such as priorities used for internal application interlocks).

As described above, the pretest is utilized to determine whether to continue to one or more full range active tests. If object state checks pass and the device configuration is valid, then pretest will indicate that testing should continue. Fault conditions that must be resolved prior to executing active tests may be identified. Examples of such fault conditions include failed sensors and/or wiring issues, among others. Other work items that must be executed prior to executing active tests, such as clearing software and/or mechanical overrides, among others, may also be identified. Fault conditions and the other work items may be identified by reviewing internal object parameters based on, and in response to, the image of the mechanical components produced from scanning each device.

Referring to FIG. 4B, there is shown a table representing full range active tests that may be applied to the building automation controllers 102, 104, in particular, an association between active tests 452 and mechanical peripherals 454. If an item found in the Peripheral Options, i.e., BAS Controller-Mechanical Device Options, column 454 is found when scanning the building automation controller 102, 104, the corresponding active test 452 will execute on the device. Examples of active tests 452 include, but are not limited to, a supply damper test 456 (associated with supply air dampers and dual duct dampers), heating coil test 458 (associated with heating coil components), heating/cooling coil test 460 (associated with heating/cooling coil components and heat pump compressors), radiator coil test 462 (associated with radiator components), cooling coil test 464 (associated with cooling coil components and chilled beams), extract camper test 466 (associated with extract air dampers), outdoor air damper test 468 (associated with outdoor air dampers), terminal fan test 470 (associated with terminal fan components), and radiant ceiling test 472 (associated with radiant ceiling components). The pretest results may be captured for use in reports, applied to functions of the building automation controller 102, 104, or any other necessary corrective. It should be noted that each active test, such as those illustrated in FIG. 4B, has a corresponding pretest, such as those described above. If a pretest fails due to fault conditions or other work items, the corresponding active test will not be executed.

The full range active tests may be performed on the full range of possible states of each device, not just at a specific state or set point. In particular, the active tests perform for the full range of capability of each device from a full open state to a full close state. For example, actuators and valves may tested through their entire range of states and analyzed for each step that is tested. In contrast, conventional tests focus on a mere state or set point (such as just to close or just to open) to determine whether a stable set point may be reached and maintained.

The full range active test may be directed the full range of capability of mechanical equipment for each controller/device in addition, or alternative, to the controller/device itself. The active tests may determine whether the mechanical equipment is functioning correctly before attempting to control the controller/device and its associated mechanical equipment. For some embodiments, the active tests are directed other capabilities, such as dead spots, reverse spots, and over travel, in addition to the full capability range of the mechanical equipment. Also, each active test is capable of operating using existing sensors of the HVAC system, i.e., without the need for additional sensors.

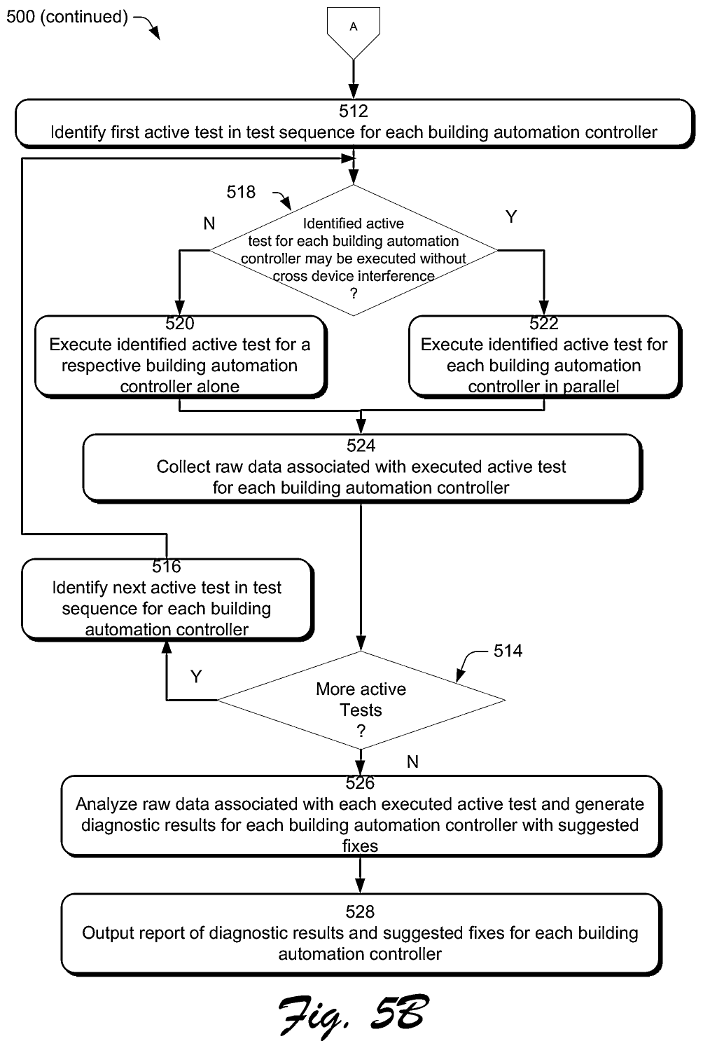

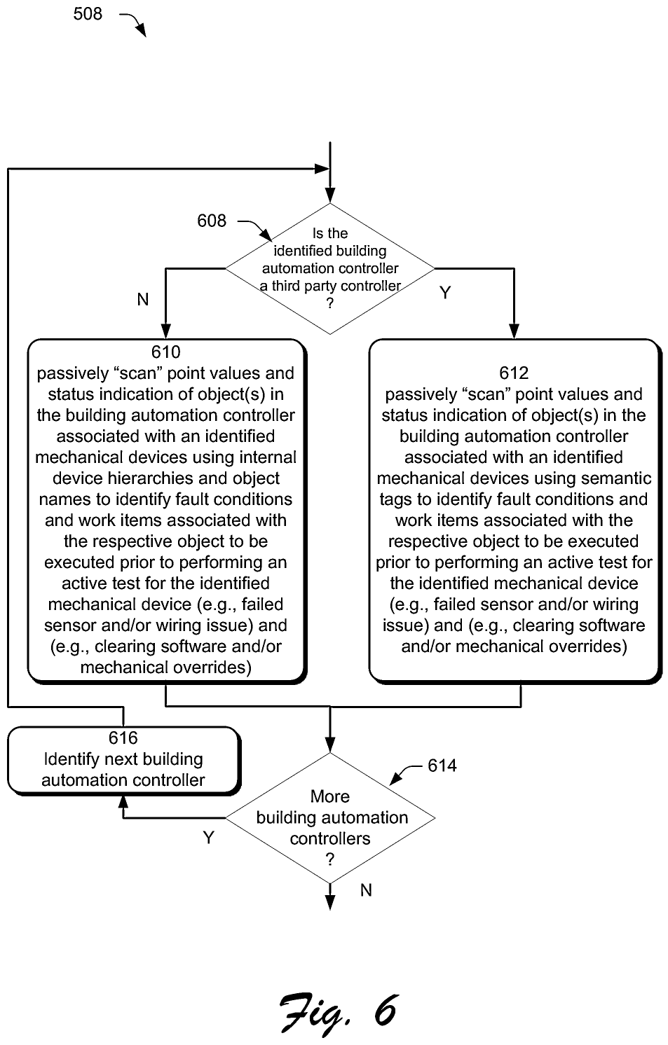

Referring to FIG. 5A and 5B, there are shown flow diagrams of an FDD operation 500 in an example implementation that is operable to employ techniques described herein. The FDD operation 500 performs active fault detection for a controller of a BAS. A remote device 114-120 receives (502) a request for active fault detection of one or more building automation controllers 102, 104 of BAS network. The building automation controller 102, 104 and the act of fault detection may occur at a facility of a customer associated with the controller. One or more FDD test apps 126, 130-134, 140, 142, depending on the embodiment, may be activated (504) at remote device 114-120 or customer gateway 136, 138 in response to receiving (502) the request for active fault detection. The BAS network is scanned to identify test candidate devices. In particular, the BAS network of an identified customer is scanned and building automation controllers 102, 104 on the BAS network are discovered (506) in response to activation (504) of one or more FDD test apps 126, 130-134, 140, 142. Each discovered device may be scanned to build an image of the mechanical components that it controls. Objects in the device may be scanned using internal device hierarchies and object names or semantic tags.

The fault detection system includes passive and active elements, in which passive steps have read-only access whereas active steps necessitate commands to be sent to the device under test. Passive tests associated with the building automation controllers 102, 104 are executed (508), and full range active tests associated with the building controllers are executed (510) in response to the execution of the passive tests. The passive tests are executed (508) by analyzing the building automation controller 102, 104 via read-only access to operations of the building automation controller. The passive test includes identifying (508) a fault condition and a work item associated with the building automation controller or a mechanical device connected to the building automation controller. For one embodiments, the passive test precedes execution of the active test and includes passively interrogating all controllers of the building automation controllers 102, 104, and identifying all fault conditions and work items associated with the building automation controllers or mechanical devices 106-112 connected to them.

In response to the passive test or tests (508), one or more full range active tests are executed (510) based on the fault condition and the work item associated with each building automation controller 102, 104 by analyzing the building automation controller via direct command access to the operations of the building automation controller (i.e., commands sent to the device under test). Tests may be executed on single devices or groups of devices. For some embodiments, active tests and a test sequence for each building automation controller 102, 104 are identified based on the fault condition and the work item associated with the building automation controller, and executing (512, 514, 516) the active tests in parallel and/or sequential order based on the test sequence for each building automation controller. For example, multiple active tests may be executed in parallel or serially for multiple controllers. Parallel may be prioritized ahead of serial processing so that the system 100 may attempt to test as many controllers in parallel as possible, thus maximizing speed and/or efficiency. If a controller has multiple tests, then the active tests may be handled sequentially, secondary to the parallel processing. Based on the results of the passive or pretests, the active tests to execute and the testing sequence for each device are identified and faults are reported as necessary. Each test is responsible for isolating the mechanical components in test. For example, to test the ability of a VAV box heating coil to reach warmup targets, the ability of the supply air fan/damper to supply a consistent, known level of airflow is first tested to assure that the coils are protected and that the test environment is similar across devices and test runs. For a multistage coil, it is necessary to first test that all stages are operational. Without this type of diagnostic procedure, the root cause of the test failure may be misidentified.

For some embodiments, a pre-requisite test is identified (510) to confirm conditions for isolating the mechanical device for the active test. For some embodiments, the operation 500 determines (518) whether the active test for each controller of the building automation controllers 102, 104 may be executed without cross device interference, executing (520) the active test for each controller in response to determining that the active test may be executed without cross device interference, and executing (522) the active test for each controller in parallel in response to determining that the active test may not be executed without cross device interference. Mechanical equipment images built previously (508) may be used to avoid cross-device interference. For example, if every VAV box in a zone is commanded to open its damper simultaneously, the test results may be impacted by lower than normal flow.

Based on, and in response to, execution of the full range active test, raw data associated with the active test is collected (524). In response to collecting the data associated with all active tests, the aggregate data is analyzed (526) to generate diagnostic results for each device with suggested fixes.

A controller function associated with the request for active fault detection of the building automation controllers 102, 104 may be performed (528) in response to executing the active test or tests. For some embodiments, the controller function includes outputting a report of diagnostic results and suggested fixes for each controller of the building automation controllers 102, 104. For some embodiments, the controller function includes performing a modification for a particular controller of the building automation controllers 102, 104 in response to executing the active test.

The aggregate data may be analyzed (526) to generate diagnostic results for one or more devices based on passing active test results as well as failing active test results. Failing active test results are not limited to failures and may also include warnings. A remote device 114-120 or customer gateway 136, 138 may detect changes in device operation of one or more building automation controllers based on a passing data set of the full range active test and a failing data set of the full range active test. For example, the remote device 114-120 or customer gateway 136, 138 may compare a passing data set for one or more controllers and a failing data set of the one or more controllers. Also, A controller function associated with the request for active fault detection of the building automation controllers 102, 104 may be performed (528) by a management module in response to detecting the changes in device operation of the controller(s) as well as executing the active test or tests.

For some embodiments, active fault detection on individual building automation controllers may include a comparison of a current active test data set to one or more previous active test data sets. In particular, one data set of the passing and failing data sets may be a first data set of a current active test for a particular controller and the other data set of the passing and failing data sets may be a second data set of a previous active test for the particular controller. The comparisons may be performed with one or multiple previous data sets to detect varying results or changes showing progressive decrease or increase in responses to commands throughout the active test. The active fault detection that includes this comparison feature may analyze relative increases or reductions in data for each test set. The comparisons may be performed for active tests generating passing results as we well as the tests that have one or more non-passing results, e.g., failures or warnings. The comparison may be performed during the same time period as an active test and provide additional information about current data indicating changes in device operation.

For some embodiments, active fault detection may be performed for multiple building automation controllers. In particular, one of the passing and failing data sets may be a first data set of an active test for a first building automation controller and the other of the passing and failing data sets may be a second data set of an active test for a second building automation controller, in which the second controller is different from the first controller. Two or more controllers may be selected for active comparison during an assigned active test. For some embodiments, the building automation controllers may be selected by association, such as controllers that serve a common zone or perform a common function. By utilizing the active fault detection for multiple controllers, within the same time frame as one or more assigned active tests, a management module may provide timely information relating to unexpected or unique differences that may be addressed at the time of the active tests or soon thereafter. For example, similar test failures at multiple controllers may indicate an external issue in comparison to a single failure that is likely to be isolated at a local controller. For some embodiments, additional analysis may be performed at the time of the active tests to identify response differences for active tests generating passing results as the subject devices are stepped-through the associated control range.

Referring to FIG. 6, there is shown a flow diagram representing the passive test operation (508) of FIG. 5 in an example implementation. Each device is scanned to build an image of the mechanical components that it controls, identify fault conditions that must be resolved prior to executing full range active test, and to identify other work items that must be executed prior to executing full range active tests. For some embodiments, the passive test includes determining (608) whether a particular controller of the building automation controllers 102, 104 is a third party controller. If the particular controller is not a third party controller, then the operation 508 scans internal object parameters, such as point values and status indications, using internal device hierarchies and object names. In particular, the operation 508 passively reviews (610) an internal object parameter, including a point value and a point status of the particular controller, and identifies the fault condition and the work item based on the point value and the point status. If the particular controller is a third party controller, then the operation 508 may scan point values and status indications using semantic tags. Scanning via internal hierarchies, point names, and/or semantic tags applies to fixed application controllers, configurable application controllers, and programmable controllers. The operation 508 may determine (614) whether more building automation controllers 102, 104 are to be scanned and, if so, identifies (616) the next building automation controller to be scanned until all controllers associated with the request and/or discovered by the system are reviewed.

Other properties of the internal object parameter may also be considered, such as object attributes, object properties, and array structures. For example, a priority array may be utilized to determine whether there is an internal or external override. This determination facilitates a decision of whether to delay the process until the internal override goes away or prevent/allow tests based on the origin of the override.

Those skilled in the art will recognize that, for simplicity and clarity, the full structure and operation of all data processing systems suitable for use with the present disclosure are not being depicted or described herein. Also, none of the various features or processes described herein should be considered essential to any or all embodiments, except as described herein. Various features may be omitted or duplicated in various embodiments. Various processes described may be omitted, repeated, performed in parallel and/or sequentially, concurrently, or in a different order. Various features and processes described herein can be combined in still other embodiments as may be described in the claims.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an example embodiment of the present disclosure has been described in detail, those skilled in the art will understand that various changes, substitutions, variations, and improvements disclosed herein may be made without departing from the spirit and scope of the disclosure in its broadest form.

What is claimed is:

1. A system for active fault detection of an HVAC system and its associated mechanical equipment comprising:
a plurality of building automation controllers of a building automation system (“BAS”) network; and
a remote device communicating with the plurality of building automation controllers, the remote device including:
a management module configured to receive a request for active fault detection of the plurality of building automation controllers; and
a test module configured to execute a passive test associated with each building automation controller of the plurality of building automation controllers by analyzing the building automation controller via read-only access to the operations of the building automation controller, the passive test including identifying a fault condition and a work item associated with the building automation controller or a mechanical device connected to the building automation controller, the test module further executing an full range active test based on the fault condition and the work item associated with the building automation controller by analyzing the building automation controller via direct command access to the operations of the building automation controller; and
wherein the management module performs a controller function associated with the request for active fault detection of the plurality of building automation controllers in response to executing the full range active test.

2. The system as described in claim 1, further comprising a customer gateway facilitating communications between the remote device and the plurality of building automation controllers, wherein at least one of the remote device or the customer gateway discovers the plurality of building automation controllers on the BAS network in response to receiving the request for active fault detection of the plurality of building automation controllers.

3. The system as described in claim 1, further comprising a customer gateway facilitating communications between the remote device and the plurality of building automation controllers, wherein, preceding the execution of the full range active test:
at least one of the remote device or the customer gateway passively interrogates all controllers of the plurality of building automation controllers; and
the remote device and at least one controller of the plurality of building automation controllers resolve all fault conditions and work items associated with the plurality of building automation controllers or mechanical devices connected to the plurality of building automation controllers.

4. The system as described in claim 1, wherein:
the remote device determines whether a particular controller of the plurality of building automation controllers is a third party controller;
the remote device passively reviews a point value and a point status of the particular controller; and
the remote device identifies the fault condition and the work item based on internal object parameters including the point value and the point status.

5. The system as described in claim 1, wherein:
the remote device identifies a plurality of full range active tests including full range control and a test sequence for each building automation controller based on the fault condition and the work item associated with the building automation controller; and
the remote device executes the plurality of full range active tests in parallel and/or sequential order based on the test sequence for each building automation controller.

6. The system as described in claim 1, wherein the remote device identifies a pre-requisite test to confirm conditions for isolating the mechanical device for the full range active test.

7. The system as described in claim 1, wherein:
the remote device determines whether the full range active test for each controller of the plurality of building automation controllers may be executed without cross device interference;
the remote device executes the full range active test for each controller in response to determining that the full range active test may be executed without cross device interference; and
the remote device executes the full range active test for each controller in parallel in response to determining that the full range active test may not be executed without cross device interference.

8. The system as described in claim 1, wherein:
the remote device detecting changes in device operation of at least one controller of the plurality of building automation controllers based on a comparison of a passing data set of the full range active test for the at least one controller and a failing data set of the full range active test for the at least one controller; and
the management module performs the controller function associated with the request for active fault detection in response to executing the full range active test and detecting the changes in device operation of the at least one controller.

9. The system as described in claim 8, wherein one of the passing and failing data sets is a first data set of a current active test for a particular controller and the other of the passing and failing data sets is a second data set of a previous active test for the particular controller.

10. The system as described in claim 8, wherein one of the passing and failing data sets is a first data set of an active test for a first building automation controller and the other of the passing and failing data sets is a second data set of an active test for a second building automation controller different from the first building automation controller.

11. The system as described in claim 1, wherein:
the remote devices collects raw data associated with full range active test; and
the remote device generates diagnostic results and suggested fixes in response to collecting the raw data associated with the full range active test.

12. The system as described in claim 1, wherein the remote devices performs at least one of:
outputting a report of diagnostic results and suggested fixes for each controller of the plurality of building automation controllers, or
performing a modification for a particular controller of the plurality of building automation controllers in response to executing the full range active test.

13. The building automation system as described in claim 1, wherein the remote device is at least one of a fault detection and diagnostics server or a fault detection and diagnostics mobile device.

14. A method for active fault detection of an HVAC system and its associated mechanical equipment comprising:
receiving a request for active fault detection of a plurality of building automation controllers of a building automation system (“BAS”) network;
executing a passive test associated with each building automation controller of the plurality of building automation controllers by analyzing the building automation controller via read-only access to operations of the building automation controller, the passive test including identifying a fault condition and a work item associated with the building automation controller or a mechanical device connected to the building automation controller;
executing an full range active test based on the fault condition and the work item associated with each building automation controller by analyzing the building automation controller via direct command access to the operations of the building automation controller; and
performing a controller function associated with the request for active fault detection of the plurality of building automation controllers in response to executing the full range active test.

15. The method as described in claim 14, further comprising discovering the plurality of building automation controllers on the BAS network in response to receiving the request for active fault detection of the plurality of building automation controllers.

16. The method as described in claim 14, wherein executing a passive test comprises, preceding executing the full range active test:
passively interrogating all controllers of the plurality of building automation controllers; and
resolving all fault conditions and work items associated with the plurality of building automation controllers or mechanical devices connected to the plurality of building automation controllers.

17. The method as described in claim 14, wherein executing a passive test comprises:
determining whether a particular controller of the plurality of building automation controllers is a third party controller;
passively reviewing a point value and a point status of the particular controller; and
identifying the fault condition and the work item based on internal object parameters including the point value and the point status.

18. The method as described in claim 14, wherein executing the full range active test comprises:
identifying a plurality of full range active tests including full range control and a test sequence for each building automation controller based on the fault condition and the work item associated with the building automation controller; and
executing the plurality of full range active tests in parallel and/or sequential order based on the test sequence for each building automation controller.

19. The method as described in claim 14, wherein executing the full range active test comprises identifying a pre-requisite test to confirm conditions for isolating the mechanical device for the full range active test.

20. The method as described in claim 14, wherein executing the full range active test for each building automation controller comprises:
determining whether the full range active test for each controller of the plurality of building automation controllers may be executed without cross device interference;
executing the full range active test for each controller in response to determining that the full range active test may be executed without cross device interference; and
executing the full range active test for each controller in parallel in response to determining that the full range active test may not be executed without cross device interference.

21. The method as described in claim 14, wherein:
executing the full range active test for each building automation controller includes detecting changes in device operation of at least one controller of the plurality of building automation controllers based on a comparison of a passing test of the at least one controller and a failing test of the at least one controller; and
performing the controller function associated with the request for active fault detection includes performing the controller function in response to executing the full range active test and detecting the changes in device operation of the at least one controller.

22. The method as described in claim 21, wherein one of the passing and failing data sets is a first data set of a current active test for a particular controller and the other of the passing and failing data sets is a second data set of a previous active test for the particular controller.

23. The method as described in claim 21, wherein one of the passing and failing data sets is a first data set of an active test for a first building automation controller and the other of the passing and failing data sets is a second data set of an active test for a second building automation controller different from the first building automation controller.

24. The method as described in claim 14, further comprising:
collecting raw data associated with full range active test; and
generating diagnostic results and suggested fixes in response to collecting the raw data associated with the full range active test.

25. The method as described in claim 14, wherein performing the controller function includes outputting a report of diagnostic results and suggested fixes for each controller of the plurality of building automation controllers.

26. The method as described in claim 14, wherein performing the controller function includes performing a modification for a particular controller of the plurality of building automation controllers in response to executing the full range active test.
